(19) United States
(12) Patent Application Publication
(10) Pub. No.: US 2018/0040907 A1
(43) Pub. Date: Feb. 8, 2018

(54) FUEL CELL STACK

(71) Applicant: HONDA MOTOR CO., LTD., TOKYO (JP)

(72) Inventors: Kentaro ISHIDA, WAKO-SHI (JP); Masaaki SAKANO, WAKO-SHI (JP); Hiroshi MORIKAWA, WAKO-SHI (JP)

(21) Appl. No.: 15/664,063

(22) Filed: Jul. 31, 2017

(30) Foreign Application Priority Data
Aug. 2, 2016 (JP) 2016-152267

(51) Int. Cl. H01M 8/0276; H01M 8/0267; H01M 8/0297; H01M 8/0258

(52) U.S. Cl. CPC H01M 8/0276; H01M 8/0258; H01M 8/0267; H01M 8/0297; H01M 2008/1095

(57) ABSTRACT

A fuel cell stack includes a stack body including a plurality of power generation cells stacked in a stacking direction. Seal lines are formed on metal separators of the power generation cells. The seal lines protrude in the stacking direction of the stack body in a manner that the seal lines contact an outer circumferential portion of the membrane electrode assembly or a resin film provided on the outer circumferential portion of the membrane electrode assembly. Elastic seal members are provided on insulators or end plates. The elastic seal members abut against seal lines of the metal separators provided at the outermost ends in the stacking direction.

### CROSS-REFERENCE TO RELATED APPLICATION

This application is based upon and claims the benefit of priority from Japanese Patent Application No. 2016-152267 filed on Aug. 2, 2016, the contents of which are incorporated herein by reference.

### BACKGROUND OF THE INVENTION

### Field of the Invention

The present invention relates to a fuel cell stack including a stack body formed by stacking a plurality of power generation cells. Each of the power generation cells includes a membrane electrode assembly and metal separators on both sides of the membrane electrode assembly. The membrane electrode assembly includes a pair of electrodes and an electrolyte membrane interposed between the electrodes.

### Description of the Related Art

For example, a solid polymer electrolyte fuel cell includes a membrane electrode assembly (MEA) having an electrolyte membrane. The electrolyte membrane is a polymer ion exchange membrane. An anode is provided on one surface of the electrolyte membrane, and a cathode is provided on the other surface of the electrolyte membrane. The membrane electrode assembly is sandwiched between separators (bipolar plates) to form a power generation cell. Normally, a predetermined number of the power generation cells are stacked together to form a stack body, and a fuel cell stack contains such a stack body. For example, the fuel cell stack is mounted in a fuel cell vehicle (fuel cell electric automobile, etc.).

In some cases, as the separators, the fuel cell stack may adopt metal separators. In this regard, seal members are provided on the metal separators for preventing leakage of an oxygen-containing gas and a fuel gas as reactant gases and a coolant (e.g., see the specification of U.S. Pat. No. 6,605,380). Elastic rubber seals such as fluorine based seals or silicone seals are used as the seal members. Therefore, the cost required for providing the seal members such as the fluorine based seals or silicone seals pushes up the production cost disadvantageously.

To this end, for example, as disclosed in Japanese Laid-Open Patent Publication No. 2015-191802, it has been common to adopt a structure where, instead of the elastic rubber seals, sealing beads are formed on metal separators.

### SUMMARY OF THE INVENTION

Sealing beads may be formed on metal separators provided on both sides of the membrane electrode assembly. The sealing beads protrude in the stacking direction of the stack body in a manner that the sealing beads contact the frame provided at the outer circumferential portion of the membrane electrode assembly. The stack body is sandwiched between insulators at both ends of the stack body in the stacking direction in a manner that the sealing beads are deformed elastically. In this manner, leakage of the reactant gases and the coolant is prevented.

However, in the structure, the elastic force of the sealing beads is applied to the frame provided on the membrane electrode assembly from both sides of the frame, and the elastic force of the sealing beads is applied to the insulator only from one side of the insulator. Therefore, a desired sealing performance may not be obtained at the ends of the stack body in the stacking direction. In view of the above, there is a demand to improve the sealing performance at the ends of the stack body in the stacking direction.

The present invention has been made taking the above points into account, and an object of the present invention is to provide a fuel cell stack which makes it possible to improve the sealing performance at ends of a stack body in the stacking direction.

A fuel cell stack according to the present invention includes a stack body including a plurality of power generation cells stacked in a stacking direction. Each of the power generation cells includes a membrane electrode assembly and metal separators provided on both sides of the membrane electrode assembly. The membrane electrode assembly includes a pair of electrodes and an electrolyte membrane interposed between the electrodes. Sealing beads are provided on the metal separators. The sealing beads protrude in the stacking direction of the stack body in a manner that the sealing beads contact an outer circumferential portion of the membrane electrode assembly or a frame provided on the outer circumferential portion of the membrane electrode assembly. Insulators and end plates sandwiching the stack body in the stacking direction are provided on both sides of the stack body in the stacking direction in a manner that the sealing beads are deformed elastically.

Elastic seal members are provided on the insulators or the end plates, and the elastic seal members are configured to abut against the sealing beads of the metal separators provided at the outermost end positions in the stacking direction.

Further, in the fuel cell stack, preferably, recesses are provided on surfaces of the insulators or the end plates facing the stack body, and the elastic seal members are provided in the recesses.

Further, preferably, each of the metal separators includes a gas flow field configured to supply a reactant gas to the electrode and a plurality of passages for the reactant gas and the coolant, and the sealing beads are formed around the gas flow field and around the passages.

Further, in the fuel cell stack, preferably, each one of the metal separators provided at the outermost end positions in the stacking direction has the same structure as another metal separator that contacts a surface of the outer circumferential portion or the frame of the membrane electrode assembly, the surface facing the opposite side of the one of the metal separators provided at the outermost end positions in the stacking direction.

In the present invention, the elastic seal member which abuts against the sealing bead of the metal separator provided at the outermost end in the stacking direction of the stack body is provided on the insulator or the end plate. In the structure, the elastic force of the elastic seal member is applied to the sealing bead of the metal separator provided at the end of the stack body in the stacking direction, and the elastic force of the sealing bead is applied to the elastic seal member. Accordingly, it is possible to improve the sealing performance at the end of the stack body in the stacking direction.

The above and other objects, features and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a perspective view showing a fuel cell stack according to an embodiment of the present invention;

FIG. 2 is a partial exploded perspective view schematically showing the fuel cell stack;

FIG. 3 is a cross sectional view taken along a line III-III in FIG. 2;

FIG. 4 is an exploded perspective view showing a power generation cell of the fuel cell stack;

FIG. 5 is a front view showing a first metal separator of the power generation cell;

FIG. 6 is a front view showing one of insulators of the fuel cell stack;

FIG. 7 is a front view showing the other of the insulators of the fuel cell stack;

FIG. 8 is a cross sectional view showing a first elastic seal member and a second elastic seal member of the fuel cell stack;

FIG. 9 is a cross sectional view showing an example of structure of the fuel cell stack according to the present invention; and

FIG. 10 is a cross sectional view showing another example of structure of the fuel cell stack according to the present invention.

### DESCRIPTION OF THE PREFERRED EMBODIMENTS

Hereinafter, preferred embodiments of a fuel cell stack according to the present invention will be described with reference to the accompanying drawings.

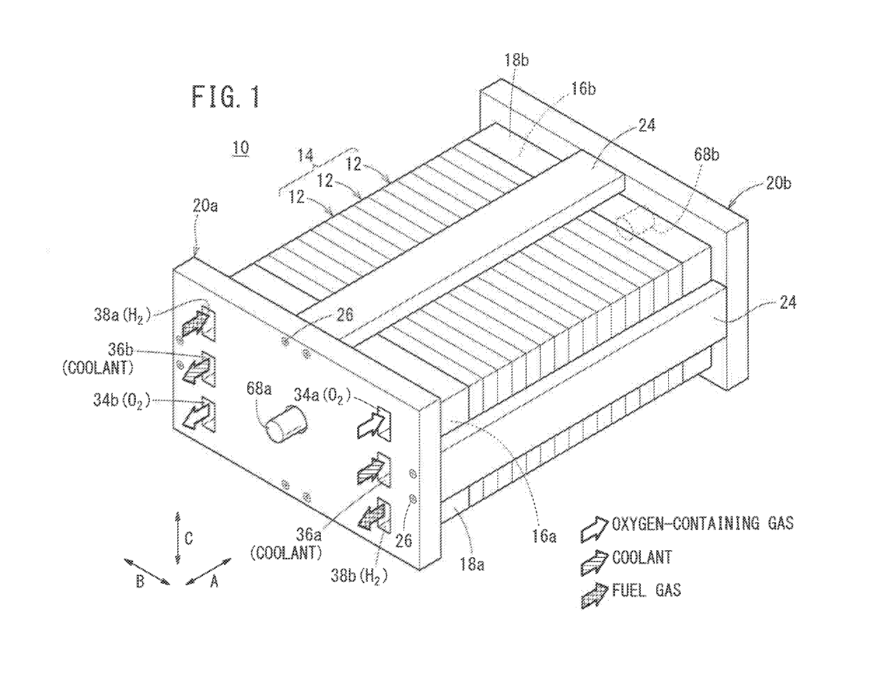

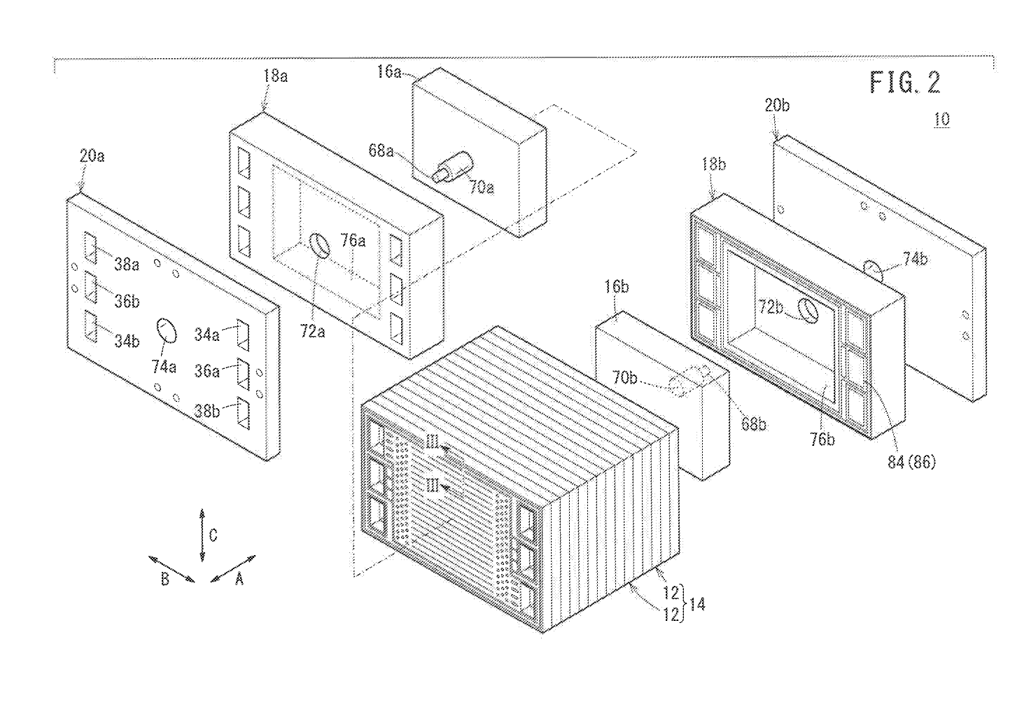

As shown in FIGS. 1 and 2, a fuel cell stack 10 according to an embodiment of the present invention includes a stack body 14 formed by stacking a plurality of power generation cells 12 in a horizontal direction (indicated by an arrow A) or in a direction of gravity (indicated by an arrow C). For example, the fuel cell stack 10 is mounted in a fuel cell vehicle such as a fuel cell electric automobile (not shown).

At one end of the stack body 14 in the stacking direction (indicated by the arrow A), a terminal plate 16a is provided. An insulator 18a is provided outside the terminal plate 16a, and an end plate 20a is provided outside the insulator 18a (see FIG. 2). At the other end of the stack body 14, a terminal plate 16b is provided. An insulator 18b is provided outside the terminal plate 16b, and an end plate 20b is provided outside the insulator 18b.

As shown in FIG. 1, the end plates 20a, 20b have a laterally elongated (or longitudinally elongated) rectangular shape, and coupling bars 24 are provided between respective sides of the end plates 20a, 20b. Both ends of the coupling bars 24 are fixed to inner surfaces of the end plates 20a, 20b using bolts 26 to apply a tightening load to the stacked power generation cells 12 in the stacking direction indicated by the arrow A. Alternatively, it should be noted that the fuel cell stack 10 may have a casing including the end plates 20a, 20b, and the stack body 14 may be placed in the casing.

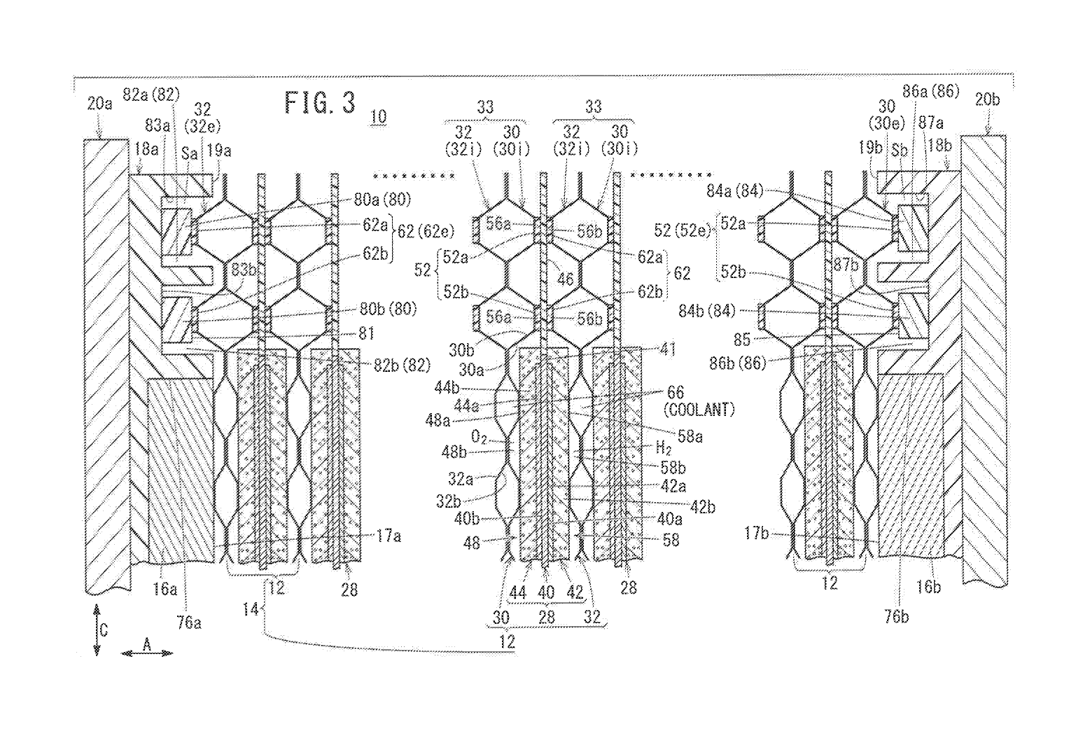

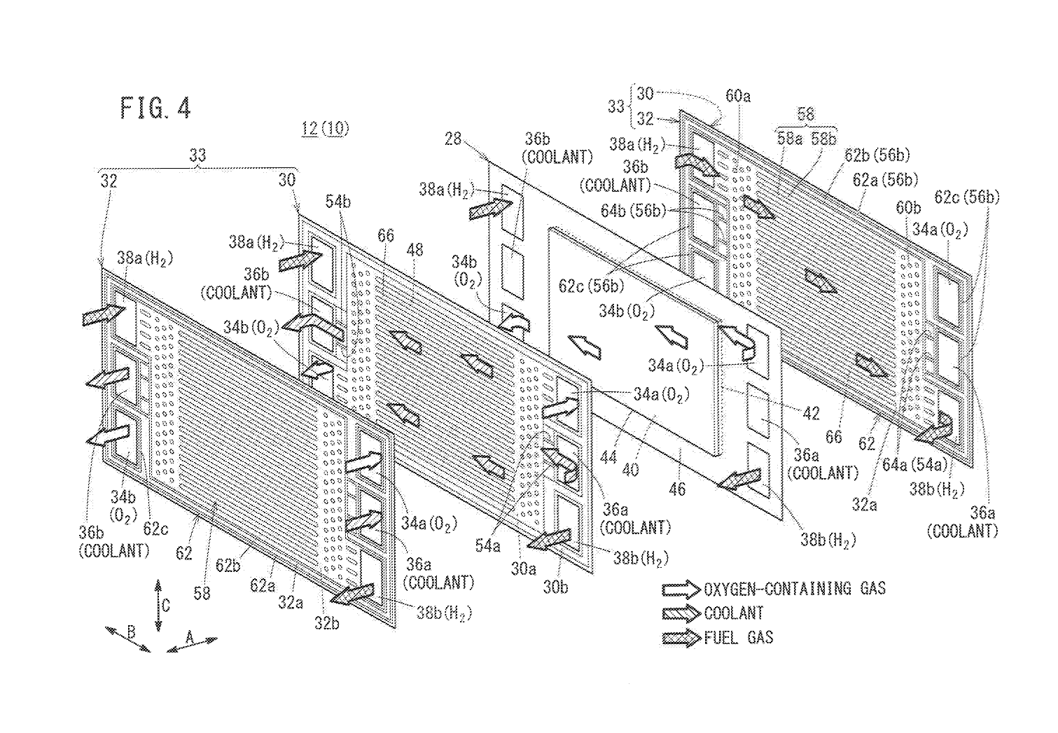

As shown in FIGS. 3 and 4, each of the power generation cells 12 is formed by sandwiching a resin film equipped MEA (membrane electrode assembly) 28 between a first metal separator 30 and a second metal separator 32. For example, the first metal separator 30 and the second metal separator 32 are metal plates such as steel plates, stainless steel plates, aluminum plates, plated steel sheets, or metal plates having anti-corrosive surfaces by surface treatment. Each of the first metal separator 30 and the second metal separator 32 is formed by corrugating the above-described metal thin plates by press forming to have a corrugated shape in cross section and a wavy or straight shape on the surface. Outer circumferential ends of the first metal separator 30 and the second metal separator 32 are joined together by welding, brazing, crimpling, etc. to form a joint separator 33.

At one end of the power generation cell 12 in a long side direction of the power generation cell 12 indicated by an arrow B (horizontal direction in FIG. 4), an oxygen-containing gas supply passage 34a, a coolant supply passage 36a, and a fuel gas discharge passage 38b are provided. The oxygen-containing gas supply passage 34a, the coolant supply passage 36a, and the fuel gas discharge passage 38b extend through the power generation cell 12 in the direction indicated by the arrow A. The oxygen-containing gas supply passage 34a, the coolant supply passage 36a, and the fuel gas discharge passage 38b are arranged in the direction indicated by an arrow C. An oxygen-containing gas is supplied through the oxygen-containing gas supply passage 34a. A coolant is supplied through the coolant supply passage 36a, and a fuel gas such as a hydrogen-containing gas is discharged through the fuel gas discharge passage 38b.

At the other end of the power generation cell 12 in the direction indicated by the arrow B, a fuel gas supply passage 38a, a coolant discharge passage 36b, and an oxygen-containing gas discharge passage 34b are provided. The fuel gas supply passage 38a, the coolant discharge passage 36b, and the oxygen-containing gas discharge passage 34b extend through the power generation cell 12 in the direction indicated by the arrow A. The fuel gas supply passage 38a, the coolant discharge passage 36b, and the oxygen-containing gas discharge passage 34b are arranged in the direction indicated by the arrow C. The fuel gas is supplied through the fuel gas supply passage 38a, the coolant is discharged through the coolant discharge passage 36b, and the oxygen-containing gas is discharged through the oxygen-containing gas discharge passage 34b. The positions of the oxygen-containing gas supply passage 34a, the oxygen-containing gas discharge passage 34b, and the fuel gas supply passage 38a, and the fuel gas discharge passage 38b are not limited to the present embodiment, and may be appropriately determined according to the required specification.

As shown in FIG. 3, the resin film equipped MEA 28 has a frame shaped resin film (frame) 46 at its outer portion. For example, the resin film equipped MEA 28 includes an anode (electrode) 42, a cathode (electrode) 44, and a solid polymer electrolyte membrane (cation exchange membrane) 40 interposed between the anode 42 and the cathode 44. The solid polymer electrolyte membrane 40 is a thin membrane of perfluorosulfonic acid containing water.

A fluorine based electrolyte may be used for the solid polymer electrolyte membrane 40. Alternatively, an HC (hydrocarbon) based electrolyte may be used for the solid polymer electrolyte membrane 40. The plane size (outer size) of the solid polymer electrolyte membrane 40 is smaller than the plane size (outer size) of the anode 42 and the plane size (outer size) of the cathode 44. The solid polymer electrolyte membrane 40 includes an overlapped portion 41 overlapped with the outer ends of the anode 42 and the cathode 44.

The anode 42 includes a first electrode catalyst layer 42a joined to one surface 40a of the solid polymer electrolyte membrane 40, and a first gas diffusion layer 42b stacked on the first electrode catalyst layer 42a. The outer size of the first electrode catalyst layer 42a is smaller than the outer size of the first gas diffusion layer 42b, and the same as (or smaller than) the outer size of the solid polymer electrolyte membrane 40. It should be noted that the outer size of the first electrode catalyst layer 42a may be the same as the outer size of the first gas diffusion layer 42b.

The cathode 44 includes a second electrode catalyst layer 44a joined to a surface 40b of the solid polymer electrolyte membrane 40, and a second gas diffusion layer 44b stacked on the second electrode catalyst layer 44a. The outer size of the second electrode catalyst layer 44a is smaller than the outer size of the second gas diffusion layer 44b, and the same as (or smaller than) the outer size of the solid polymer electrolyte membrane 40. It should be noted that the outer size of the second electrode catalyst layer 44a may be the same as the outer size of the second gas diffusion layer 44b.

The first electrode catalyst layer 42a is formed, for example, by depositing porous carbon particles uniformly on the surface of the first gas diffusion layer 42b. Platinum alloy is supported on surfaces of the carbon particles. The second electrode catalyst layer 44a is formed, for example, by depositing porous carbon particles uniformly on the surface of the second gas diffusion layer 44b. Platinum alloy is supported on surfaces of the carbon particles. Each of the first gas diffusion layer 42b and the second gas diffusion layer 44b comprises a carbon paper, a carbon cloth, etc. The first electrode catalyst layer 42a and the second electrode catalyst layer 44a are formed on respective both surfaces 40a, 40b of the solid polymer electrolyte membrane 40.

A resin film 46 having a frame shape is sandwiched between an outer edge portion of the first gas diffusion layer 42b and an outer edge portion of the second gas diffusion layer 44b. An inner end surface of the resin firm 46 is positioned close to, or contacts an outer end surface of the solid polymer electrolyte membrane 40. As shown in FIG. 4, the oxygen-containing gas supply passage 34a, the coolant supply passage 36a, and the fuel gas discharge passage 38b are provided at one end of the resin film 46 in the direction indicated by the arrow B. The fuel gas supply passage 38a, the coolant discharge passage 36b, and the oxygen-containing gas discharge passage 34b are provided at the other end of the resin film 46 in the direction indicated by the arrow B.

For example, the resin film 46 is made of PPS (polyphenylene sulfide), PPA (polyphthalamide), PEN (polyethylene naphthalate), PES (polyether sulfone), LCP (liquid crystal polymer), PVDF (polyvinylidene fluoride), a silicone resin, a fluorine resin, m-PPE (modified polyphenylene ether resin), PET (polyethylene terephthalate), PBT (polybutylene terephthalate), or modified polyolefin. It should be noted that the solid polymer electrolyte membrane 40 may protrude outward without using the resin film 46. Further, a pair of frame shaped films may be provided on respective both sides of the solid polymer electrolyte membrane 40 which protrudes outward.

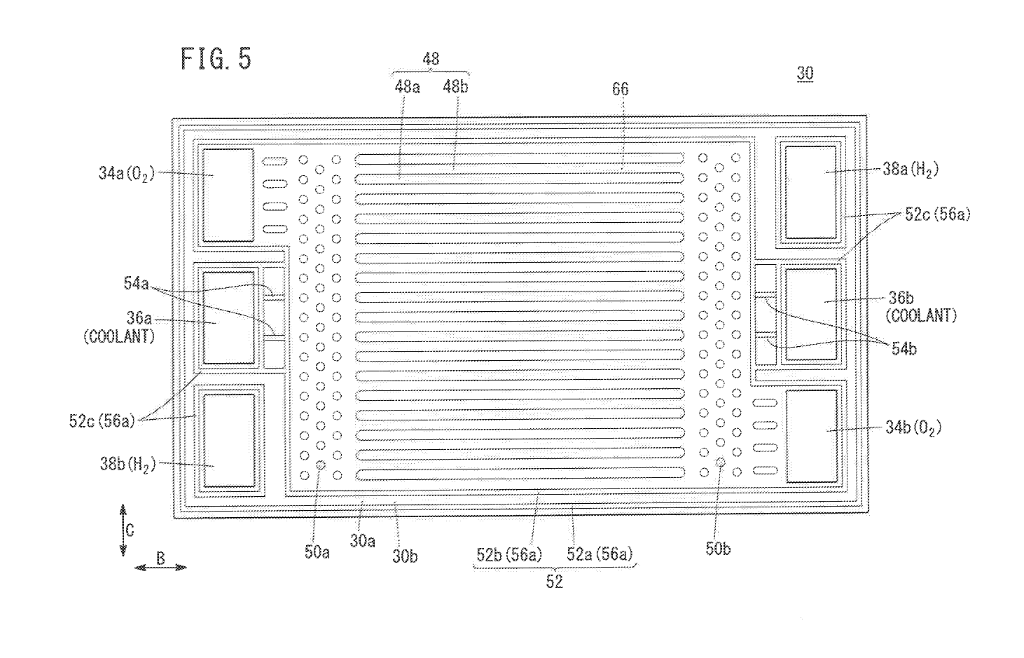

As shown in FIG. 4, the first metal separator 30 has an oxygen-containing gas flow field 48 on its surface 30a facing the resin film equipped MEA 28. For example, the oxygen-containing gas flow field 48 extends in the direction indicated by the arrow B. As shown in FIG. 5, the oxygen-containing gas flow field 48 is in fluid communication with the oxygen-containing gas supply passage 34a and the oxygen-containing gas discharge passage 34b. The oxygen-containing gas flow field 48 includes straight flow grooves (or wavy flow grooves) 48b between a plurality of ridges 48a extending in the direction indicated by the arrow B.

An inlet buffer 50a having a plurality of bosses is provided between the oxygen-containing gas supply passage 34a and the oxygen-containing gas flow field 48. An outlet buffer 50b having a plurality of bosses is provided between the oxygen-containing gas discharge passage 34b and the oxygen-containing gas flow field 48.

The oxygen-containing gas flow field 48, the inlet buffer 50a, the outlet buffer 50b, and a first seal line (metal bead seal) 52 each having a corrugated shape in cross section by press forming, are formed on the surface 30a of the first metal separator 30. The oxygen-containing gas flow field 48, the inlet buffer 50a, the outlet buffer 50b, and the first seal line are expanded toward the resin film equipped MEA 28. The first seal line 52 includes an outer bead (sealing bead) 52a formed around the outer marginal portion of the surface 30a. As shown in FIG. 3, the first seal line 52 has a tapered shape in cross section toward the front end of the first seal line 52. The front end of the first seal line 52 has a flat shape or an R shape. Further, the first seal line 52 includes an inner bead (sealing bead) 52b formed around the oxygen-containing gas flow field 48, the oxygen-containing gas supply passage 34a, and the oxygen-containing gas discharge passage 34b, while allowing the oxygen-containing gas flow field 48, the oxygen-containing gas supply passage 34a, and the oxygen-containing gas discharge passage 34b to communicate with each other.

Further, the first seal line 52 includes passage beads (sealing bead) 52c formed around the fuel gas supply passage 38a, the fuel gas discharge passage 38b, the coolant supply passage 36a, and the coolant discharge passage 36b. The outer bead 52a, the inner bead 52b, and the passage bead 52c protrude from the surface 30a. The outer bead 52a should be provided as necessary, i.e., the outer bead 52a may not be provided.

As shown in FIG. 5, the first metal separator 30 includes a plurality of inlet channels 54a and a plurality of outlet channels 54b. The inlet channels 54a connect a coolant flow field 66 (described later) formed on a surface 30b of the first metal separator 30 with the coolant supply passage 36a. The outlet channels 54b connect the coolant flow field 66 with the coolant discharge passage 36b. Each of the inlet channels 54a and the outlet channels 54b extends in the direction indicated by the arrow B. Part of the first metal separator 30 is expanded from the surface 30a to thereby form the inlet channels 54a and the outlet channels 54b. The number and shape of each of the inlet channels 54a and the outlet channels 54b can be determined arbitrarily.

The inlet channels 54a are connected to the inner bead 52b and the passage bead 52c between the coolant flow field 66 and the coolant supply passage 36a. The outlet channels 54b are connected to the inner bead 52b and the passage bead 52c between the coolant flow field 66 and the coolant discharge passage 36b.

In the first seal line 52, as shown in FIG. 3, a resin material 56a is fixed to each of protruding front end surfaces of the outer bead 52a and the inner bead 52b by printing, coating, or the like. For example, polyester is used as the resin material 56a. As shown in FIG. 5, the resin material 56a is fixed to a protruding front surface of the passage bead 52c by printing, coating, or the like. Alternatively, as the resin material 56a, punched-out sheets having the plane surface shapes corresponding to the shapes of the outer bead 52a, the inner bead 52b, and the passage bead 52c may be attached to the surface 30a of the first metal separator 30. The resin material 56a should be provided as necessary, i.e., the resin material 56a may not be provided.

As shown in FIG. 4, the second metal separator 32 has a fuel gas flow field 58 on its surface 32a facing the resin film equipped MEA 28. For example, the fuel gas flow field 58 extends in the direction indicated by the arrow B. The fuel gas flow field 58 is in fluid communication with the fuel gas supply passage 38a and the fuel gas discharge passage 38b. The fuel gas flow field 58 includes straight flow grooves (or wavy flow grooves) 58b between a plurality of ridges 58a extending in the direction indicated by the arrow B.

An inlet buffer 60a having a plurality of bosses is provided between the fuel gas supply passage 38a and the fuel gas flow field 58. An outlet buffer 60b having a plurality of bosses is provided between the fuel gas discharge passage 38b and the fuel gas flow field 58.

The fuel gas flow field 58, the inlet buffer 60a, the outlet buffer 60b, and a second seal line (metal bead seal) 62 each having a corrugated shape in cross section by press forming, are formed on the surface 32a of the second metal separator 32. The fuel gas flow field 58, the inlet buffer 60a, the outlet buffer 60b, and the second seal line 62 are expanded toward the resin film equipped MEA 28. The second seal line 62 includes an outer bead (sealing bead) 62a formed around the outer marginal portion of the surface 32a. As shown in FIG. 3, the second seal line 62 has a tapered shape in cross section toward the front end of the second seal line 62. The front end of the second seal line 62 has a flat shape or an R shape. Further, the second seal line 62 includes an inner bead (sealing bead) 62b formed around the fuel gas flow field 58, the fuel gas supply passage 38a, and the fuel gas discharge passage 38b, while allowing the fuel gas flow field 58, the fuel gas supply passage 38a, and the fuel gas discharge passage 38b to communicate with each other.

Further, the second seal line 62 includes passage bead (sealing bead) 62c formed around the oxygen-containing gas supply passage 34a, the oxygen-containing gas discharge passage 34b, the coolant supply passage 36a, and the coolant discharge passage 36b. The outer bead 62a, the inner bead 62b, and the passage bead 62c protrude from the surface 32a. The outer bead 62a should be provided as necessary, i.e., the outer bead 62a may not be provided.

As shown in FIG. 4, the second metal separator 32 includes a plurality of inlet channels 64a and a plurality of outlet channels 64b. The inlet channels 64a connect a coolant flow field 66 (described later) formed on a surface 32b of the second metal separator 32 with the coolant supply passage 36a. The outlet channels 64b connect the coolant flow field 66 with the coolant discharge passage 36b. Each of the inlet channels 64a and the outlet channels 64b extends in the direction indicated by the arrow B. Part of the second metal separator 32 is expanded from the surface 32a to thereby form the inlet channels 64a and the outlet channels 64b. The number and shape of each of the inlet channels 64a and the outlet channels 64b can be determined arbitrarily.

The inlet channels 64a are connected to the inner bead 62b and the passage bead 62c between the coolant flow field 66 and the coolant supply passage 36a. The outlet channel 64b is connected to the inner bead 62b and the passage bead 62c between the coolant flow field 66 and the coolant discharge passage 36b.

In the second seal line 62, as shown in FIG. 3, a resin material 56b is fixed to each of protruding front end surfaces of the outer bead 62a and the inner bead 62b by printing, coating, or the like. For example, polyester is used as the resin material 56b. As shown in FIG. 4, the resin material 56b is fixed to a protruding front surface of the passage bead 62c by printing, coating, or the like. Alternatively, as the resin material 56b, punched-out sheets having the plane surface shapes corresponding to the shapes of the outer bead 62a, the inner bead 62b, and the passage bead 62c may be attached to the surface 32a of the second metal separator 32. The resin material 56b should be provided as necessary, i.e., the resin material 56b may not be provided.

The coolant flow filed 66 is formed between adjacent metal separators 30, 32 that are joined together, i.e., between the surface 30b of the first metal separator 30 and the surface 32b of the second metal separator 32. The coolant flow field 66 fluidically communicates with the coolant supply passage 36a and the coolant discharge passage 36b. The coolant flow field 66 is formed by stacking the back surface of the oxygen-containing gas flow field 48 of the first metal separator 30 and the back surface of the fuel gas flow field 58 of the second metal separator 32 together.

The terminal plates 16a, 16b shown in FIG. 2 are made of electrically conductive material. For example, the terminal plates 16a, 16b are made of metal such as copper, aluminum or stainless steel. Terminal units 68a, 68b extending outward in the stacking direction are provided at substantially the centers of the terminal plates 16a, 16b.

The terminal unit 68a is inserted into an electric insulating tubular body 70a. The terminal unit 68a then passes through a hole 72a of the insulator 18a and a hole 74a of the end plate 20a, and protrudes to the outside of the end plate 20a. The terminal unit 68b is inserted into an electric insulating tubular body 70b. The terminal unit 68b then passes through a hole 72b of the insulator 18b and a hole 74b of the end plate 20b, and protrudes to the outside of the end plate 20b.

As shown in FIG. 2, the insulators 18a, 18b are made of electric insulating material such as polycarbonate (PC) or phenolic resin. Recesses 76a, 76b are formed at the centers of the insulators 18a, 18b, respectively. The recesses 76a, 76b are opened to the stack body 14. The holes 72a, 72b are formed at the bottom surfaces of the recesses 76a, 76b, respectively.

The oxygen-containing gas supply passage 34a, the coolant supply passage 36a, and the fuel gas discharge passage 38b extend through one end of each of the insulator 18a and the end plate 20a in the direction indicated by the arrow B. The fuel gas supply passage 38a, the coolant discharge passage 36b, and the oxygen-containing gas discharge passage 34b extend through the other end of each of the insulator 18a and the end plate 20a in the direction indicated by the arrow B.

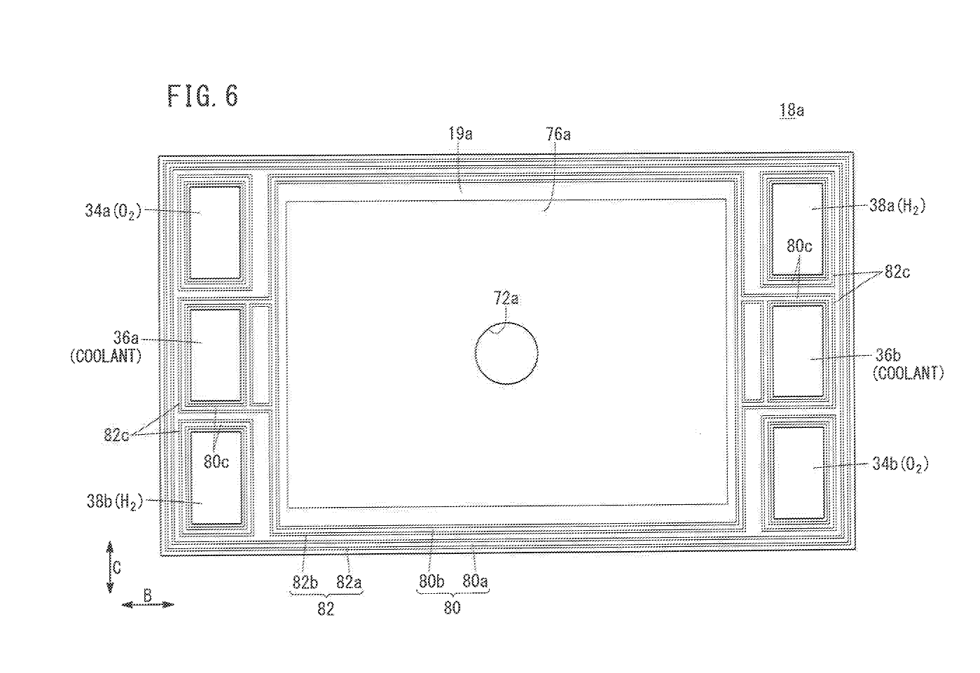

As shown in FIGS. 3 and 6, a first recess 82 is formed on a surface 19a of the insulator 18a facing the stack body 14. A first elastic seal member 80 is provided in the first recess 82. The first elastic seal member 80 abuts against the second seal line 62 of the second metal separator 32 provided at the outermost end of the stack body 14 in the stacking direction (on the insulator 18a side). In the following description, the second metal separator 32 provided at the outermost end in the stacking direction of the stack body 14 on the insulator 18a side will also be referred to as the “second end metal separator 32e”, and the second seal line 62 of the second end metal separator 32e will also be referred to as the “second end seal line 62e”.

A predetermined gap Sa is formed between the first elastic seal member 80 and a side surface 83a of the first recess 82 so as to allow the first elastic seal member 80 to be deformed elastically in a direction perpendicular to the stacking direction (i.e., in a direction indicated by the arrow B or C). Specifically, the width of the first recess 82 is larger than the width of the first elastic seal member 80. The first elastic seal member 80 is spaced from the side surface 83a of the first recess 82. The first elastic seal member 80 is spaced from the side surface 83a of the first recess 82 by a substantially constant distance. The gap Sa is provided on each of both sides of the first elastic seal member 80 in the width direction.

For example, the first elastic seal member 80 has a rectangular shape in lateral cross section, and made of elastic polymer material. For example, such polymer material includes a silicone rubber, an acrylic rubber, a nitrile rubber, etc. The first elastic seal member 80 is attached (by adhesive) or fused to a bottom surface 83b of the first recess 82.

A surface 81 of the first elastic seal member 80 facing the second end seal line 62e is positioned inside the first recess 82 for allowing the second end metal separator 32e to tightly contact the terminal plate 16a. Stated otherwise, the surface 81 of the first elastic seal member 80 is arranged at a position shifted from a surface 17a of the terminal plate 16a facing the second end metal separator 32e, toward the bottom surface 83b of the first recess 82. Further, the surface 81 of the first elastic seal member 80 has a flat shape in parallel to the solid polymer electrolyte membrane 40 (i.e., in parallel to a surface perpendicular to the stacking direction of the stack body 14).

The first recess 82 includes an outer recess 82a formed at a position facing the outer bead 62a of the second end seal line 62e, an inner recess 82b formed at a position facing the inner bead 62b of the second end seal line 62e, and a passage recess 82c formed at a position facing the passage bead 62c of the second end seal line 62e.

The first elastic seal member 80 includes an outer seal 80a provided inside the outer recess 82a, an inner seal 80b provided inside the inner recess 82b, and a passage seal 80c provided inside the passage recess 82c.

That is, the outer seal 80a is formed around the outer marginal portion of the surface 19a of the insulator 18a, and abuts against the outer bead 62a of the second end seal line 62e. The inner seal 80b is formed around the recess 76a, and abuts against the inner bead 62b of the second end seal line 62e. The passage seal 80c is formed around the fuel gas supply passage 38a, the fuel gas discharge passage 38b, the coolant supply passage 36a, and the coolant discharge passage 36b, and abuts against part of the inner bead 62b that surrounds the fuel gas supply passage 38a and the fuel gas discharge passage 38b, and the passage bead 62c of the second end seal line 62e.

In the embodiment of the present invention, as can be seen from FIG. 6, the outer seal 80a and the inner seal 80b are provided separately. A portion of the passage seal 80c around the coolant supply passage 36a and the coolant discharge passage 36b is formed separately from the outer seal 80a, but formed integrally with the inner seal 80b. Part of the passage seal 80c that surrounds the oxygen-containing gas supply passage 34a, the oxygen-containing gas discharge passage 34b, the fuel gas supply passage 38a, and the fuel gas discharge passage 38b is formed separately from the outer seal 80a and the inner seal 80b.

Alternatively, the outer recess 82a, the inner recess 82b, and the passage recess 82c may be formed so as to connect with each other, and the outer seal 80a, the inner seal 80b, and the passage seal 80c may be formed integrally. The outer seal 80a and the outer recess 82a should be provided as necessary, i.e., the outer seal 80a and the outer recess 82a may not be provided.

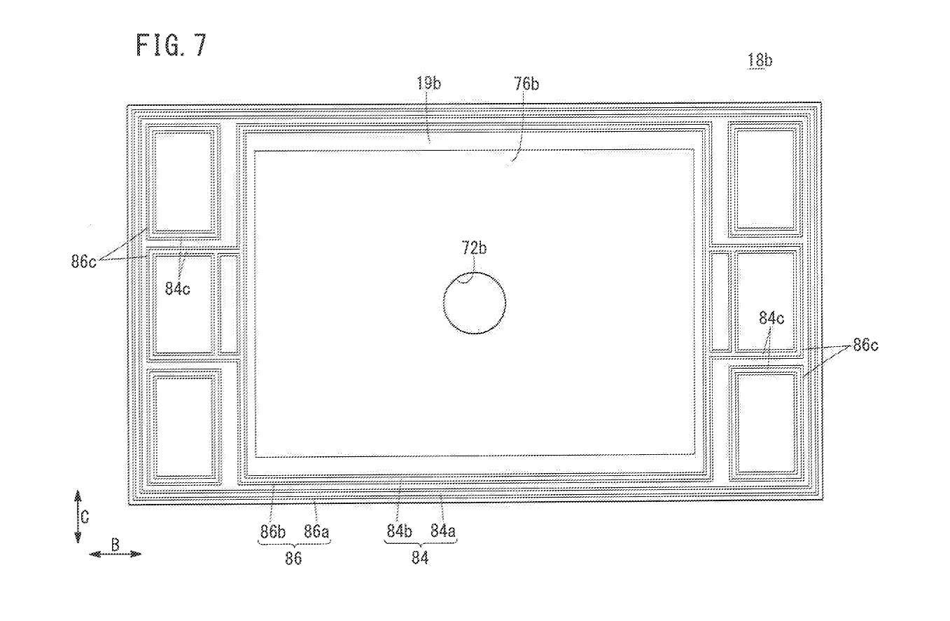

As shown in FIGS. 3 and 7, a second recess 86 is formed on a surface 19b of the insulator 18b facing the stack body 14. A second elastic seal member 84 is provided in the second recess 86. The second elastic seal member 84 abuts against the first seal line 52 of the first metal separator 30 provided at the outermost end of the stack body 14 in the stacking direction on the insulator 18b side. In the following description, the first metal separator 30 provided at the outermost end in the stacking direction of the stack body 14 on the insulator 18b side will also be referred to as the “first end metal separator 30e”, and the first seal line 52 of the first end metal separator 30e will also be referred to as the “first end seal line 52e”.

A predetermined gap Sb is formed between the second elastic seal member 84 and a side surface 87a of the second recess 86 so as to allow the second elastic seal member 84 to be deformed elastically in a direction perpendicular to the stacking direction (i.e., in a direction indicated by the arrow B or C). Specifically, the width of the second recess 86 is larger than the width of the second elastic seal member 84. The second elastic seal member 84 is spaced from the side surface 87a of the second recess 86. The second elastic seal member 84 is spaced from the side surface 87a of the second recess 86 by a substantially constant distance. The gap Sb is provided on each of both sides of the second elastic seal member 84 in the width direction.

For example, the second elastic seal member 84 has a rectangular shape in lateral cross section, and made of elastic polymer material. For example, such polymer material includes a silicone rubber, an acrylic rubber, a nitrile rubber, etc. The second elastic seal member 84 is attached (by adhesive) or fused to a bottom surface 87b of the second recess 86.

A surface 85 of the second elastic seal member 84 facing the first end seal line 52e is positioned inside the second recess 86 for allowing the first end metal separator 30e to tightly contact the terminal plate 16b. Stated otherwise, the surface 85 of the second elastic seal member 84 is arranged at a position shifted from a surface 17b of the terminal plate 16b facing the first end metal separator 30e, toward the bottom surface 87b of the second recess 86. Further, the surface 85 of the second elastic seal member 84 has a flat shape in parallel to the solid polymer electrolyte membrane 40 (i.e., in parallel to a surface perpendicular to the stacking direction of the stack body 14).

The second recess 86 includes an outer recess 86a formed at a position facing the outer bead 52a of the first end seal line 52e, an inner recess 86b formed at a position facing the inner bead 52b of the first end seal line 52e, and a passage recess 86c formed at a position facing the passage bead 52c of the first end seal line 52e.

The second elastic seal member 84 includes an outer seal 84a provided inside the outer recess 86a, an inner seal 84b provided inside the inner recess 86b, and a passage seal 84c provided inside the passage recess 86c.

That is, the outer seal 84a is formed around the outer marginal portion of the surface 19b of the insulator 18b, and abuts against the outer bead 52a of the first end seal line 52e. The inner seal 84b is formed around the recess 76b, and portions facing the oxygen-containing gas supply passage 34a and the oxygen-containing gas discharge passage 34b of the first end metal separator 30e, and abuts against the inner bead 52b of the first end seal line 52e. The passage seal 84c is formed around portions facing the fuel gas supply passage 38a, the fuel gas discharge passage 38b, the coolant supply passage 36a, and the coolant discharge passage 36b of the first end metal separator 30e and abuts against the passage bead 52c of the first end seal line 52e.

In the embodiment of the present invention, as can be seen from FIG. 7, the outer seal 84a and the inner seal 84b are provided separately. Part of the passage seal 84c around the portions facing the coolant supply passage 36a and the coolant discharge passage 36b of the first end metal separator 30e, is formed separately from the outer seal 84a, but formed integrally with the inner seal 84b. Another part of the passage seal 84c around the portions facing the fuel gas supply passage 38a and the fuel gas discharge passage 38b of the first end metal separator 30e, is formed separately from the outer seal 84a and the inner seal 84b.

Alternatively, the outer recess 86a, the inner recess 86b, and the passage recess 86c may be formed so as to connect with each other, and the outer seal 84a, the inner seal 84b, and the passage seal 84c may be formed integrally. The outer seal 84a and the outer recess 86a should be provided as necessary, i.e., the outer seal 84a and the outer recess 86a may not be provided.

As can be seen from FIG. 3, in the fuel cell stack 10, the first end metal separator 30e has the same structure as each of the first metal separators 30 provided at intermediate positions of the stack body 14 in the stacking direction (hereinafter also referred to as the “first intermediate metal separators 30i”). Stated otherwise, the first end metal separator 30e has the same structure as each of the first intermediate metal separators 30i which contacts a surface of the resin film 46 that is on the opposite side of the first end metal separator 30e. That is, all of the first metal separators 30 have the same structure.

Further, the second end metal separator 32e has the same structure as each of the second metal separators 32 provided at intermediate positions of the stack body 14 in the stacking direction (hereinafter also referred to as the “second intermediate metal separators 32i”). Stated otherwise, the second end metal separator 32e has the same structure as each of the second intermediate metal separators 32i which contact a surface of the resin film 46 that is on the opposite side of the second end metal separator 32e. That is, all of the second metal separators 32 have the same structure.

In the fuel cell stack 10, the coupling bars 24 are fixed to the inner surfaces of the end plates 20a, 20b using the bolts 26 in a manner that the first seal line 52 and the second seal line 62 are deformed elastically. In this manner, a tightening load is applied to the stack body 14 in the stacking direction. Therefore, the resin film 46 is sandwiched between the first seal line 52 and the second seal line 62 in the stacking direction in a manner that the first seal line 52 and the second seal line 62 are deformed elastically. That is, since the elastic force of the first seal line 52 and the elastic force of the second seal line 62 are applied to the resin film 46, leakage of the oxygen-containing gas, the fuel gas, and the coolant is prevented.

Next, operation of the fuel cell stack 10 having the above structure will be described below.

Firstly, as shown in FIG. 1, an oxygen-containing gas such as the air is supplied to the oxygen-containing gas supply passage 34a at the end plate 20a. A fuel gas such as a hydrogen-containing gas is supplied to the fuel gas supply passage 38a at the end plate 20a. A coolant such as pure water, ethylene glycol, oil, or the like is supplied to the coolant supply passage 36a at the end plate 20a.

As shown in FIG. 4, the oxygen-containing gas flows from the oxygen-containing gas supply passage 34a to the oxygen-containing gas flow field 48 at the first metal separator 30. The oxygen-containing gas flows along the oxygen-containing gas flow field 48 in the direction indicated by the arrow B, and the oxygen-containing gas is supplied to the cathode 44 of the membrane electrode assembly 28.

In the meanwhile, the fuel gas is supplied from the fuel gas supply passage 38a to the fuel gas flow field 58 of the second metal separator 32. The fuel gas flows along the fuel gas flow field 58 in the direction indicated by the arrow B, and the fuel gas is supplied to the anode 42 of the membrane electrode assembly 28.

Thus, in each of the membrane electrode assemblies 28, the oxygen-containing gas supplied to the cathode 44 and the fuel gas supplied to the anode 42 are consumed in the electrochemical reactions in the second electrode catalyst layer 44a and the first electrode catalyst layer 42a of the cathode 44 and the anode 42 for generating electricity.

Then, the oxygen-containing gas consumed at the cathode 44 flows along the oxygen-containing gas discharge passage 34b, and is discharged in the direction indicated by the arrow A. Likewise, the fuel gas consumed at the anode 42 flows along the fuel gas discharge passage 38b, and is discharged in the direction indicated by the arrow A.

Further, the coolant supplied to the coolant supply passage 36a flows into the coolant flow field 66 formed between the first metal separator 30 and the second metal separator 32. Then, the coolant flows in the direction indicated by the arrow B. After the coolant cools the membrane electrode assembly 28, the coolant is discharged from the coolant discharge passage 36b.

In the embodiment of the present invention, the first elastic seal member 80 is provided on the insulator 18a, and the first elastic seal member 80 abuts against the second end seal line 62e of the second end metal separator 32e. In the structure, the elastic force of the first elastic seal member 80 is applied to the second end seal line 62e, and the elastic force of the second end seal line 62e is applied to the first elastic seal member 80. Further, the second elastic seal member 84 is provided on the insulator 18b, and the second elastic seal member 84 abuts against the first end seal line 52e of the first end metal separator 30e. In the structure, the elastic force of the second elastic seal member 84 is applied to the first end seal line 52e, and the elastic force of the first end seal line 52e is applied to the second elastic seal member 84. Therefore, improvement in the sealing performance at both ends of the stack body 14 in the stacking direction is achieved.

Further, the first recess 82 is formed in the surface 19a of the insulator 18a to provide the first elastic seal member 80 in the first recess 82, and the second recess 86 is formed in the surface 19b of the insulator 18b to provide the second elastic seal member 84 in the second recess 86. In the structure, it is possible to reduce the size of the stack body 14 in the stacking direction.

Further, the first seal line 52 is provided around the oxygen-containing gas flow field 48, and around the oxygen-containing gas supply passage 34a, the oxygen-containing gas discharge passage 34b, the fuel gas supply passage 38a, the fuel gas discharge passage 38b, the coolant supply passage 36a, and the coolant discharge passage 36b. Further, the second seal line 62 is provided around the fuel gas flow field 58, and around the oxygen-containing gas supply passage 34a, the oxygen-containing gas discharge passage 34b, the fuel gas supply passage 38a, the fuel gas discharge passage 38b, the coolant supply passage 36a, and the coolant discharge passage 36b. In the structure, it is possible to reliably prevent leakage of the reactant gases (oxygen-containing gas and the fuel gas) and the coolant.

In the embodiment of the present invention, all of the first metal separators 30 have the same structure, and all of the second metal separators 32 have the same structure. That is, since no dedicated component parts are required for the first end metal separator 30e and the second end metal separator 32e, it is possible to reduce the types of component parts of the fuel cell stack 10, and achieve reduction in the number of production steps of the fuel cell stack 10.

For example, if power generation of the fuel cell stack 10 is started, the temperature of the fuel cell stack 10 is increased. If power generation of the fuel cell stack 10 is stopped, the temperature of the fuel cell stack 10 is decreased. In general, the difference between the linear expansion coefficient of the joint separator 33 and the linear expansion coefficient of the insulators 18a, 18b is relatively large.

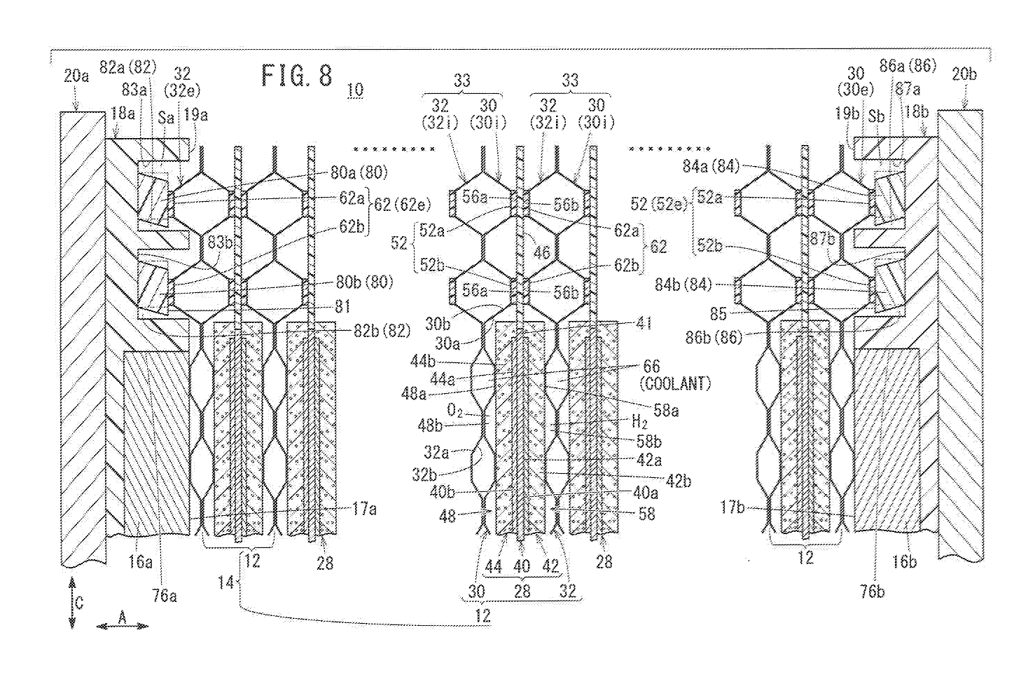

However, in the embodiment of the present invention, the second seal line 62 does not contact the insulator 18a, but contacts the first elastic seal member 80. Therefore, for example, as shown in FIG. 8, even in the case where the positional relationship between the insulator 18a and the second seal line 62 is shifted in the direction indicated by the arrow C by heat expansion or heat contraction, since the first elastic seal member 80 is deformed elastically, it is possible to suppress displacement of the contact position between the second seal line 62 and the first elastic seal member 80.

Likewise, the first seal line 52 does not contact the insulator 18b, but contacts the second elastic seal member 84. Therefore, for example, even in the case where the positional relationship between the insulator 18b and the first seal line 52 is shifted in the direction indicated by the arrow C by heat expansion or heat contraction, since the first elastic seal member 80 is deformed elastically, it is possible to suppress displacement of the contact position between the second seal line 62 and the first elastic seal member 80. Accordingly, it is possible to suppress degradation of the sealing performance at the ends of the stack body 14 in the stacking direction which may occur as a result of the change in the temperature of the fuel cell stack 10.

Further, the predetermined gap Sa is formed between the first elastic seal member 80 and the side surface 83a of the first recess 82, and the predetermined gap Sb is formed between the second elastic seal member 84 and the side surface 87a of the second recess 86. In the structure, it is possible to ensure that the first elastic seal member 80 and the second elastic seal member 84 are easily deformed elastically.

Further, since the surface 81 of the first elastic seal member 80 facing the stack body 14 has the flat shape, it is possible to efficiently ensure that the second end seal line 62e contacts the surface 81 of the first elastic seal member 80 tightly. Further, since the surface 85 of the second elastic seal member 84 facing the stack body 14 has the flat shape, it is possible to ensure that the first end seal line 52e efficiently contacts the surface 85 of the second elastic seal member 84 tightly.

The present invention is not limited to the above structure. For example, the first elastic seal member 80 may be provided on the flat surface 19a of the insulator 18a where the first recess 82 is not formed, and the second elastic seal member 84 may be provided on the flat surface 19b of the insulator 18b where the second recess 86 is not formed. In this case, since there is no need to provide the first recess 82 and the second recess 86, it is possible to simplify the structure of the insulators 18a, 18b.

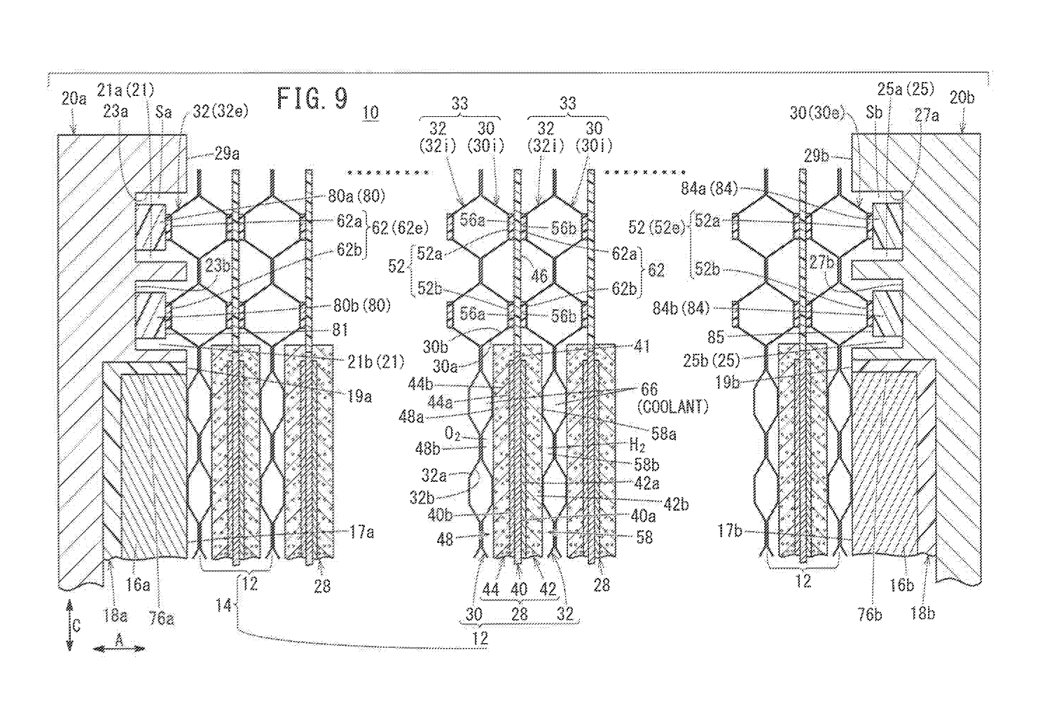

Further, in the above described embodiment, the first elastic seal member 80 is provided on the insulator 18a, and the second elastic seal member 84 is provided on the insulator 18b. However, as shown in FIG. 9, in the case where the insulators 18a, 18b are slightly smaller than the joint separator 33, the first elastic seal member 80 may be provided in a first recess 21 of the end plate 20a, and the second elastic seal member 84 may be provided in a second recess 25 of the end plate 20b.

In this case, the gap Sa is formed between the first elastic seal member 80 and a side surface 23a of the first recess 21, and in this state, the first elastic seal member 80 is attached or fused to a bottom surface 23b of the first recess 21. Specifically, an outer seal 80a (first elastic seal member 80) is provided in an outer recess 21a (first recess 21) of the end plate 20a, and an inner seal 80b (first elastic seal member 80) is provided in an inner recess 21b (first recess 21) of the end plate 20a.

The gap Sb is formed between the second elastic seal member 84 and a side surface 27a of the second recess 25, and in this state, the second elastic seal member 84 is attached or fused to a bottom surface 27b of the second recess 25. Further, the outer seal 84a (second elastic seal member 84) is provided in an outer recess 25a (second recess 25) of the end plate 20b, and the inner seal 84b (second elastic seal member 84) is provided in an inner recess 25b (second recess 25) of the end plate 20b.

It should be noted that the first elastic seal member 80 may be provided on the surface 29a of the end plate 20a and the second elastic seal member 84 may be provided on the surface 29b of the end plate 20b. In this case, since there is no need to provide the first recess 21 and the second recess 25, it is possible to simplify the structure of the end plates 20a, 20b.

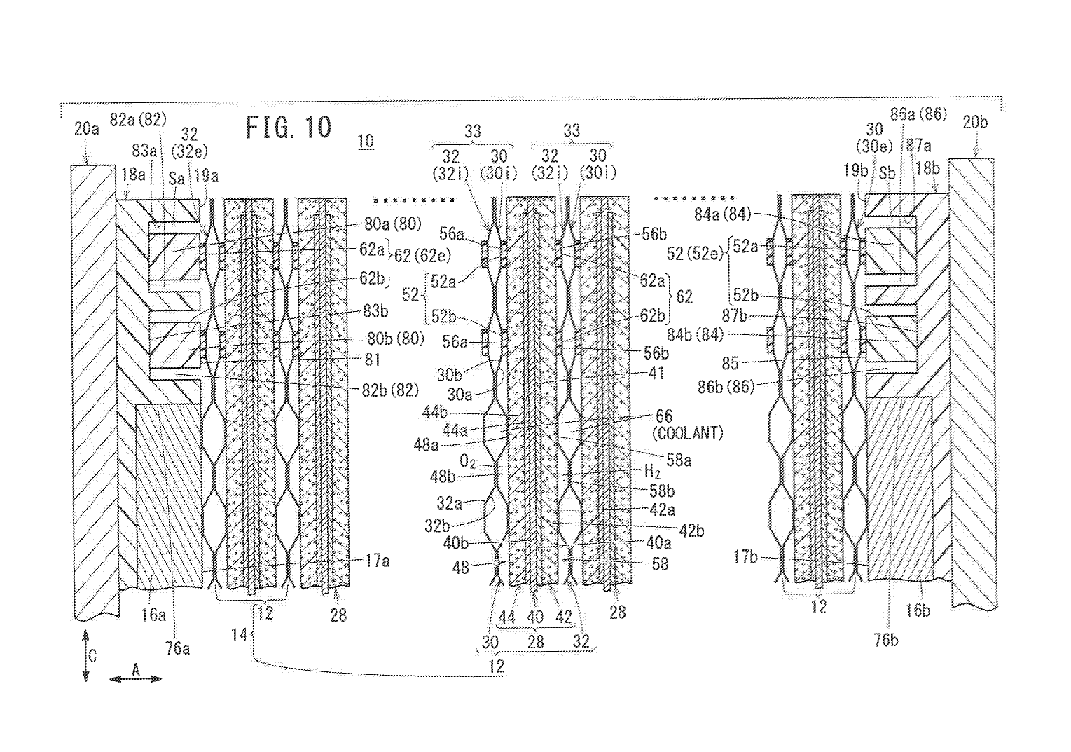

In the above described embodiment, the seal line 52 is formed on the first metal separator 30, and the seal line 52 protrudes in the stacking direction of the stack body 14 in a manner to contact the resin film 46. The seal line 62 is formed on the second metal separator 32, and the seal line 62 protrudes in the stacking direction of the stack body 14 in a manner to contact the resin film 46. However, in the present invention, as shown in FIG. 10, the seal lines 52, 62 may be provided to contact the outer circumferential portion of the membrane electrode assembly 28 which does not have the resin film 46. In this case, in order to effectively suppress leakage of the fuel gas and the oxygen-containing gas, preferably, the seal lines 52, 62 are formed by impregnating the outer circumferential portion of the membrane electrode assembly 28 therewith.

In the embodiment of the present invention, the resin film equipped MEA 28 is sandwiched between the first metal separator 30 and the second metal separator 32 to thereby form the power generation cell 12, and the coolant flow field 66 is formed in each space between the adjacent power generation cells 12, whereby a cooling structure for cooling each of the power generation cells 12 is provided. Alternatively, for example, three or more metal separators and two or more membrane electrode assemblies (MEAs) may be provided, and the metal separators and the membrane electrode assemblies may be stacked alternately to thereby form a cell unit. In this case, so called a skip cooling structure where a coolant flow field is formed between the adjacent cell units is provided.

In the skip cooling structure, a fuel gas flow field is formed on one surface of a single metal separator, and an oxygen-containing gas flow field is formed on the other surface of the single metal separator. Therefore, one metal separator is provided between membrane electrode assemblies.

The fuel cell stack according to the present invention is not limited to the above described embodiments. It is a matter of course that various structures can be adopted without deviating from the scope of the present invention.

What is claimed is:

1. A fuel cell stack comprising a stack body comprising a plurality of power generation cells stacked in a stacking direction, the power generation cells each including a membrane electrode assembly and metal separators provided on both sides of the membrane electrode assembly, the membrane electrode assembly including a pair of electrodes and an electrolyte membrane interposed between the electrodes,
wherein sealing beads are provided on the metal separators, the sealing beads protruding in the stacking direction of the stack body in a manner that the sealing beads contact an outer circumferential portion of the membrane electrode assembly or a frame provided on the outer circumferential portion of the membrane electrode assembly;
insulators and end plates sandwiching the stack body in the stacking direction are provided on both sides of the stack body in the stacking direction in a manner that the sealing beads are deformed elastically; and
elastic seal members are provided on the insulators or the end plates, and the elastic seal members are configured to abut against the sealing beads of the metal separators provided at outermost end positions in the stacking direction.

2. The fuel cell stack according to claim 1, wherein recesses are provided on surfaces of the insulators or the end plates facing the stack body, and the elastic seal members are provided in the recesses.

3. The fuel cell stack according to claim 1, wherein each of the metal separators includes a gas flow field configured to supply a reactant gas to the electrode, and a plurality of passages for the reactant gas and the coolant; and
the sealing beads are formed around the gas flow field and around the passages.

4. The fuel cell stack according to claim 1, wherein each one of the metal separators provided at the outermost end positions in the stacking direction has a same structure as another metal separator that contacts a surface of the outer circumferential portion or the frame of the membrane electrode assembly, the surface facing an opposite side of the one of the metal separators provided at the outermost end positions in the stacking direction.
